(19) United States
(12) Patent Application Publication
(10) Pub. No.: US 2005/0252598 A1
(43) Pub. Date: Nov. 17, 2005

(54) Viscous adhesive material for fastening electronic components

(76) Inventor: Martin Reiss, Dresden (DE)

Correspondence Address: SLATER & MATSIL LLP, 17950 PRESTON ROAD, SUITE 1000, DALLAS, TX, 75252, US

(21) Appl. No.: 11/122,333

(22) Filed: May 4, 2005

(30) Foreign Application Priority Data
May 4, 2004 (DE) 10 2004 022 232.0

(51) Int. Cl. B32B 31/00

(52) U.S. Cl. 156/64; 156/275.7; 156/325

(57) ABSTRACT

A viscous adhesive material can be used for fastening electronic components on a planar surface, such as a substrate. The adhesive material emits or reflects electromagnetic radiation of the visible spectral range, or a range adjacent to the visible range.

This application claims priority to German Patent Application 10 2004 022 232.0, which was filed May 4, 2004, and is incorporated herein by reference.

### TECHNICAL FIELD

The invention relates to viscous adhesive material for fastening electronic components on a planar surface, for example a substrate.

### BACKGROUND

The mechanical fastening of electronic components is required in a wide variety of situations. One important application is the fastening of unpackaged semiconductor components (chips) or of substrate-based, packaged components (IC packages) on a substrate, for example on a printed circuit board (PCB) or else on a module strip (leadframe). In particular, adhesive attachment in the manufacture of substrate-based IC packages on production lines is gaining in significance and presents particular requirements with regard to reproducibility of the topography of the adhesive application and reliability of the adhesive bond.

It is known for electronic components to be adhesively attached on planar surfaces by means of prefabricated adhesive strips (tapes) or by means of viscous adhesive material, which is applied to one of the adhesive surfaces by printing or punctiform application (dispensing). Since tape sets limits with regard to the flexibility of the adhesive bond required for absorbing stresses (thermal loads) and proves to be disadvantageous with regard to adaptation to changing component sizes, and also causes higher costs, the use of viscous adhesive material for inline processes in particular is gaining in significance.

To be able to ensure the required reproducibility and reliability of the adhesive bond even when viscous adhesive material is used in inline processes, at least the same precision that can also be achieved with tape is required with this adhesive material and its application technologies with regard to metering and positioning.

The required testing of the adhesive application is performed with respect to the positioning of the adhesive material, its amount and here in particular the thickness, and also with respect to possible contamination of the adhesive surface by foreign particles. Visual inspection, measurements with a laser profilometer or with a 3D microscope come into consideration for these tests. However, for inline production processes, these tests are restricted to inspections of random samples, since their possible cycle times cannot bear any relation to the cycle times of such a production line, which currently produces up to one leadframe every 30 seconds and 60 components per leadframe. At these cycle rates, the rate of loss increases enormously if deviations in the processing are only established on the basis of such a random sample.

For the continuous testing of various types of material application, for example solder paste, 3D measuring equipment is known. However, this equipment cannot be used for measuring the adhesive material, since on the one hand the required measuring speed for inline measurement cannot be achieved in the adhesive attachment process and on the other hand the processable polymer substances that are most expedient as adhesives are for the most part transparent. A further major disadvantage is the very high costs of this measuring equipment, which is currently approximately three times that of the production equipment.

### SUMMARY OF THE INVENTION

In one aspect, the invention provides a viscous adhesive material for the fastening of electronic components, which can be applied by the known methods and permits continuous testing even for inline processes.

For example, the adhesive material can emit or reflect electromagnetic radiation of the visible spectral range, or a range adjacent to the visible range.

This property of the adhesive material makes it possible to carry out the manufacturing process, or at least the testing process, under the light of the wavelengths for which the adhesive material is optically sensitized and, for example, by means of a digital image capturing system (imaging system) that carries out continuous image recording and analysis and also data archiving required for quality assurance, and provides the data for the further manufacturing process, allowing those pads of the applied adhesive material that do not meet the requirements with regard to positioning and size to be localized and excluded as a result in the subsequent, ongoing process. Systematic or steadily increasing deviations in the process of the adhesive application can in this way be established in the same way as troublesome splashes occurring during the application of the adhesive on the surrounding substrate unintentionally or as a result of deviating properties of the adhesive material, so that the processing provides immediate correction with a low rate of loss. An accumulated formation of bubbles in the adhesive material can also be very easily detected in this way.

The optical sensitization of the adhesive material also allows visual inspections to be carried out wherever, for example, this material is not only used for the inline manufacturing processes or, exceptionally, random sample inspections are adequate, and similarly if the inspections serve for establishing contamination of the tools or the installation.

In a particularly advantageous refinement of the invention, it is provided that the adhesive material is luminescent. Since the adhesive material for the adhesive attachment of electronic components is often a polymer, such adhesive materials that are already luminescent themselves or can be modified by suitable methods in such a way that they have an intrinsic luminescence are possible. For the modification, the side groups of the polymers are re-formed in particular, so that the other material properties remain essentially unchanged and the customary methods of applying the adhesive and process parameters for producing the adhesive bond do not have to be adapted, or only within small limits.

This particular optical sensitization of the adhesive material allows particularly accurate delimiting detection of the printed or dispensed adhesive material (adhesive pads), relatively independently of the customary surrounding lighting, under ultraviolet light. The use of such luminescent adhesive material, which emits light immediately, or only with a very small delay in the range of a few tens of nanoseconds, when excitation through the UV light occurs (fluorescence), is advantageous in particular for application in inline process inspections.

The use of luminescent or fluorescent adhesive material or else colored adhesive material allows not only the described localization and size determination of the adhesive pad but also, in a particularly advantageous way, its thickness determination, in that the luminous intensity of the emitted light is determined and correspondingly assigned to known characteristic curves of specific thicknesses. This task can also be undertaken by a correspondingly programmed imaging system.

In a way corresponding to the possibilities of the modification of the adhesive material and the lighting of the electronic components to be adhesively attached and also meeting the requirements of the characteristic variables to be determined of the adhesive material, further developments of the adhesive material according to the invention contain luminescent substances or have colored substances added. While, as described, the contained luminescent substances emit light as a result of excitation with light in the UV wavelength range, the added colored substances reflect in a known way a specific wavelength of the visible light, so that the image capturing can in both cases be performed unproblematically with corresponding filters.

While the modification of the polymer adhesives to obtain intrinsic luminescence is applied in particular when it is required to avoid disturbing additives, the adding of luminescent or colored fillers comes into consideration if a simple method of setting these properties of the viscous material or only small amounts thereof are required. Since the adding of fillers is a tried-and-tested method, this refinement according to the invention also ensures the uniformity required for the reproducibility of the image capturing and analysis with regard to the amount and distribution of the additives and at the same time a consistent printing or dispensing process.

Alternatively, it is also possible in the same way to use a modified adhesive material that has the desired optical sensitization as a result of the modification (modification of the polymer side chain).

The invention is to be explained in more detail below on the basis of an exemplary embodiment.

### DETAILED DESCRIPTION OF ILLUSTRATIVE EMBODIMENTS

Components (ICs) are to be adhesively attached on substrates on an inline production line and the individual adhesive pads for producing the connection between the IC chip and the substrate are to be continuously tested with regard to position and thickness after their application.

For this purpose, a pasty adhesive material that is self-fluorescent is used for example. It is applied to the substrates by means of a screen printing process and thereby positioned and apportioned by the correspondingly formed printing stencil and set viscosity and wetting (flowability). Directly after the application, image capturing of the printed substrate is performed by means of an imaging system and the analysis of the recording with regard to the position and luminous intensity is performed by correspondingly programmed software.

This software generally also realizes the evaluation by continuously counteracting as far as possible drift effects remaining within the tolerance range that are observed in the material application or by excluding the printed substrate unit that does not meet requirements in the subsequent process. The image capturing and evaluation by means of an imaging system additionally permits the logging and archiving of the captured data for a standardized quality assurance system (e.g., SPC or statistical process control).

In the exemplary embodiment described, a self-fluorescent adhesive material was used, but it is alternatively possible in the same way also to use a modified adhesive material that has the desired optical sensitization as a result of the modification (modification of the polymer side chain), or to use such an adhesive material to which fluorescent substances allowing the use of an imaging system for visual inspection have been added.

1. A viscous adhesive material for fastening components on a planar surface, wherein the adhesive material emits or reflects electromagnetic radiation of the visible spectral range, or a range adjacent to the visible range.

2. The viscous adhesive material for fastening components as claimed in claim 1, wherein the adhesive material is luminescent.

3. The viscous adhesive material for fastening components as claimed in claim 2, wherein the adhesive material has added colored substances suitable for the use of an imaging system.

4. The viscous adhesive material for fastening components as claimed in claim 1, wherein the adhesive material contains luminescent substances.

5. The viscous adhesive material for fastening components as claimed in claim 4, wherein the adhesive material has added colored substances suitable for the use of an imaging system.

6. The viscous adhesive material for fastening components as claimed in claim 1, wherein the adhesive material has an optical sensitization by a modified polymer side chain.

7. The viscous adhesive material for fastening components as claimed in claim 1, wherein the adhesive material emits electromagnetic radiation of the visible spectral range.

8. The viscous adhesive material for fastening components as claimed in claim 1, wherein the adhesive material reflects electromagnetic radiation of the visible spectral range.

9. The viscous adhesive material for fastening components as claimed in claim 1, wherein the adhesive material emits electromagnetic radiation of a range adjacent to the visible range.

10. The viscous adhesive material for fastening components as claimed in claim 1, wherein the adhesive material reflects electromagnetic radiation of a range adjacent to the visible range.

11. A method of attaching a component to a planar surface, the method comprising:
providing the planar surface;
applying a viscous adhesive material to the planar surface, wherein the adhesive material emits or reflects electromagnetic radiation of the visible spectral range, or a range adjacent to the visible range; and
fastening the component to the planar surface using the adhesive material.

12. The method of claim 11, wherein the planar surface comprises a surface of a substrate and wherein the component comprises an unpackaged semiconductor chip.

13. The method of claim 11, wherein the planar surface comprises a surface of a lead frame and wherein the component comprises an unpackaged semiconductor chip.

14. The method of claim 11, wherein the planar surface comprises a surface of a substrate and wherein the component comprises a packaged semiconductor chip.

15. The method of claim 11, further comprising monitoring the applying and/or fastening using an imaging system.

16. The method of claim 15, further comprising archiving information derived from the monitoring.

17. The method of claim 15, wherein the adhesive material is luminescent and wherein the adhesive material has added colored substances suitable for the use of the imaging system.

18. The method of claim 11, further comprising visually inspecting the applying and/or fastening.

19. The method of claim 11, wherein the adhesive material is luminescent.

20. The method of claim 11, wherein the adhesive material contains luminescent substances.
